(19) United States
(12) Patent Application Publication
(10) Pub. No.: US 2025/0307657 A1
(43) Pub. Date: Oct. 2, 2025

(54) SYSTEM USING TRANSFORMER ARCHITECTURE WITH QUANTIZATION-AWARE NON-LINEAR APPROXIMATION AND NEAR-MEMORY COMPUTING

(71) Applicants: The Hong Kong University of Science and Technology, Hong Kong (CN); AI Chip Center for Emerging Smart Systems Limited, Hong Kong (CN)

(72) Inventors: Pingcheng DONG, Hong Kong (CN); Yonghao TAN, Hong Kong (CN); Xijie HUANG, Hong Kong (CN); Shih-Yang LIU, Hong Kong (CN); Luhong LIANG, Hong Kong (CN); Tim Kwang-Ting CHENG, Hong Kong (CN); Dong ZHANG, Hong Kong (CN); Xuejiao LIU, Hong Kong (CN); Yu LIU, Hong Kong (CN); Peng LUO, Hong Kong (CN)

(21) Appl. No.: 19/026,573

(22) Filed: Jan. 17, 2025

Related U.S. Application Data
(60) Provisional application No. 63/570,238, filed on Mar. 27, 2024.

(51) Int. Cl. G06N 3/12

(52) U.S. Cl. CPC G06N 3/12

(57) ABSTRACT

This invention proposes a GQA-LUT method, utilizing a genetic algorithm and LUT-based circuit to efficiently approximate non-linear operators in Transformers. It adaptively finds optimal solutions for various non-linear functions, outperforming conventional neural network methods. A novel rounding mutation (RM) algorithm enhances approximation accuracy during quantization, improving low-bit integer precision. The invention also introduces a LayerNorm folding strategy as a near-memory computing principle, reducing IO and energy overheads with a two-stage memory hierarchy. Additionally, an additive partial sum quantization method is proposed to reduce energy consumption by quantizing accumulated PSUMs in matrix multiplication, alongside a PSQ-APSQ grouping strategy and floating-point regularization.

### TECHNICAL FIELD

The present invention relates to efficient hardware implementations for non-linear operations in Transformer models. More specifically, it pertains to a genetic LUT-Approximation algorithm (GQA-LUT) for INT8 quantization and a near-memory architecture.

### BACKGROUND

The introduction of Transformer-based neural networks has heralded a significant shift in the landscape of natural language processing and computer vision, thanks to a powerful self-attention mechanism that adeptly captures long-range dependencies. However, this breakthrough comes at the cost of increased computational and memory overhead. In response, extensive research has been dedicated to making Transformers more amenable to deployment on edge devices. Strategies such as integrating lightweight structures that combine convolution with linear attention have emerged, alongside a growing preference for quantization and runtime pruning to alleviate hardware demands.

Despite these efforts, the optimization of non-linear operations within Transformers remains an underexplored area, often overshadowed by the reliance on high-precision arithmetic, such as 32-bit floating-point (FP32) or integer (INT32) operations, which significantly escalates hardware costs. According to some works, the inefficiency of non-linear operations seriously impedes the speed-up of Transformers at lots of hardware platforms. Furthermore, operations like Softmax and LayerNorm in Transformer-based accelerators induce substantial data movements between on-chip SRAM and computation cores, adversely affecting both power efficiency and processing speed.

In the domain of tailored neural network accelerators, the adoption of quantization schemes, typically in single-precision (e.g., INT8) or mixed-bit formats, has become prevalent. These compression methods often employ a dyadic arithmetic pipeline for integer-only computation together with several scaling factors.

Numerous studies have been dedicated to addressing the computational challenges associated with non-linear operations in neural networks. For instance, one of the related works introduces a method known as I-BERT to approximate GELU, Softmax, and LayerNorm functions using quantization-aware 32-bit integer (INT32) arithmetic.

To further reduce the hardware resource consumption and power consumption of Softmax, one of the related works designs a method based on long-sum exponent and utilized piecewise linear approximation (PLA) multiple times to approximate the exponential and logarithmic functions within it. Also, one of the related works develops a low-precision Softmax technique employing a base replacement strategy.

Furthermore, one of the related works proposes a deep neural network architecture using PLA based on floating-point precision. While these approaches offer a way to speed up non-linear operations with minimal impact on accuracy, they suffer from a lack of universality due to the unique computational dataflows required by each optimized operator.

To this end, a neural network-based general PLA framework NN-LUT is proposed to approximate any non-linear function and store the parameters in the look-up table (LUT). Nonetheless, this framework still relies on a large number of parameters unrelated to the input data range, leading to inefficient hardware utilization since the optimal parameters for various ranges of input data differ. Efforts to refine these methods include simplifying the LUT-based PLA by factorizing floating-point data and applying single-entry approximation on the mantissa for a limited range.

However, when high-precision approximation techniques are applied to INT8 inputs, it leads to an inefficient use of resources due to the significantly lower expressiveness of INT8 compared to FP/INT32. In view of above, as of now, there exist no methodologies that simultaneously leverage low-bit integer (INT8) precision while being aware of quantization effects.

Therefore, there is a need for a methodology that efficiently optimizes non-linear operations in Transformer models by leveraging low-bit integer (e.g., INT8) precision while being fully aware of quantization effects, to address hardware inefficiencies and reduce resource consumption.

### SUMMARY OF INVENTION

It is an objective of the present invention to provide a system and a method to address the aforementioned shortcomings and unmet needs in the state of the art.

In accordance with a first aspect of the present invention, a system is provided. The system is with an improved approximation architecture performing piece-wise linear approximation method for efficient transformer acceleration. The system includes a LUT-based approximation circuit, a quantization-aware enhancement module, a low-bit LUT-based piece-wise linear approximation circuit, and a memory module. The LUT-based approximation circuit is configured to utilize a genetic algorithm for adaptively approximating non-linear operators. The genetic algorithm evaluates multiple candidate solutions to generate optimal approximation parameters. The LUT-based approximation circuit utilizes the parameters to convert at least one original floating-point operation into at least one fixed-point operation, such that the LUT-based approximation circuit outputs a transformed fixed-point representation of the original floating-point operation based on the approximation parameters. The quantization-aware enhancement module is configured to execute a rounding mutation algorithm, which treats a conversion from floating-point to integer as a mutation process. The quantization-aware enhancement module works in conjunction with the LUT-based approximation circuit by refining a fixed-point output from the LUT-based approximation circuit through rounding values in a way that minimizes quantization errors while maintaining precision, such that the quantization-aware enhancement module outputs a quantized integer representation of the transformed fixed-point operation. The low-bit LUT-based piece-wise linear approximation circuit is configured to store all approximation parameters in INT8 format, reducing memory and computational overhead. The low-bit LUT-based piece-wise linear approximation circuit receives the quantized integer representation from the quantization-aware enhancement module and performs piece-wise linear approximation, such that the low-bit LUT-based piece-wise linear approximation circuit outputs a low-bit approximation of the non-linear operation. The memory module is configured to store the low-bit approximation of the non-linear operation in a memory-efficient INT8 format.

In accordance with a second aspect of the present invention, a near-memory computing engine for Softmax and LayerNorm operations is provided. The near-memory computing engine includes a near-memory architecture model, a piece-wise linear approximation engine, and a LayerNorm folding module. The near-memory architecture model is tailored to reduce data movement burden associated with Softmax and LayerNorm computations. The piece-wise linear approximation engine is implemented via the LUT-based approximation circuit and is configured to utilize a look-up table and a quantization method to minimize data transfers and enhance overall computational efficiency. The LayerNorm folding module is configured to reduce required parameters and computation steps.

By the configuration above, there are at least three novel features provided by the present invention, summarized as follows:

(1): A LUT-Approximation technique that utilizes a genetic algorithm to perform approximation for any non-linear operators, which is named GQA-LUT.

(2): A quantization-aware rounding mutation (RM) algorithm is proposed to further improve the approximation accuracy through imaging the quantization as a certain kind of mutation process in a genetic algorithm.

(3): To alleviate the burden of data movement caused by the Softmax and LayerNorm, a PLA engine based on near-memory computing is proposed, which can reduce the enormous data movement between the computing module and the global buffer (GBuf). Additionally, LayerNorm folding strategy is proposed to transfer the elementwise transform to convolution, which reduces the energy consumption of buffer access and computation.

Further, a novel additive PSUM quantization strategy, denoted as APSQ, is introduced to specifically address challenges in WS and IS associated with large PSUMs. In APSQ, each quantizer is enabled to consider cumulative prior outcomes rather than focusing solely on the current PSUM. Additionally, a grouping strategy is introduced, combining APSQ and PSQ with a floating-point alignment regularization to avoid redundant rounding on PSUM due to its additive inherence. The strategy comprises (i) a novel additive partial sum quantization (APSQ) method, where the accumulation effect is incorporated into the quantizer; and (ii) a grouping strategy that integrates PSUM quantization (PSQ) and APSQ with a floating-point regularization technique to enhance accuracy while minimizing accuracy loss and reducing energy costs.

### BRIEF DESCRIPTION OF DRAWINGS

Embodiments of the invention are described in more details hereinafter with reference to the drawings, in which:

FIG. 1A illustrates the implementation of high-precision (FP32 or INT32) LUT-based PLA without input quantization in hardware;

FIG. 1B illustrates the implementation of proposed low-precision (INT8 or INT16) LUT-based PLA with input quantization in hardware;

FIG. 1C provides a schematic diagram of the operation mechanics of the improved approximation method and architecture of the present invention;

FIG. 2 describes the specific implementation steps of the GQA-LUT algorithm;

FIG. 3 describes the accuracy of PLA on various scaling factors;

FIG. 4 demonstrates a visualization of the error of PLA caused by quantization;

FIG. 5 illustrates the rounding mutation algorithm;

FIG. 6 analyzes the energy performance of Softmax engine with near memory computing;

FIG. 7 analyzes the energy performance of folding LayerNorm with near memory computing;

FIG. 8 illustrates the architecture of SPU;

FIG. 9 demonstrates a schematic diagram of the analytical DNN accelerator of the present invention;

FIG. 10A demonstrates an example of pointwise convolution with tile-based computation scheme;

FIGS. 10B and 10C illustrates INT-8 partial sum quantization and additive partial sum quantization, respectively;

FIG. 11 illustrates the grouping strategy algorithm;

FIGS. 12A and 12B respectively illustrates the accuracy and extra quantization times across different group sizes under Segformer-B0 and Efficient ViT-B0;

FIG. 12C shows a Table for comparison of PSUM quantization methods;

FIGS. 13A and 13B shows the analyses of normalized energy across diverse dataflows, precision, partial sum quantization methodologies and group sizes of Segformer-B0 and EfficientViT-B0 under IS and WS, respectively;

FIGS. 14A and 14B indicate that as the Bo constraint tightens, the normalized energy for larger gs escalates, particularly within the IS dataflow; and

FIG. 15 shows a schematic diagram of a system with an improved approximation architecture performing piece-wise linear approximation method for efficient transformer acceleration according to one embodiment of the present invention.

### DETAILED DESCRIPTION OF THE INVENTION

In the following description, systems and methods using genetic LUT-Approximation algorithm (GQA-LUT) for INT8 quantization and a near-memory architecture and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

Advantages or improvement of the invention over prior art:

A detailed comparison between the proposed GQA-LUT and the state-of-the-art PLA method NN-LUT is conducted, initially examining the accuracy of these methods at the operator level across a range of non-linear functions. Subsequently, it assesses the fine-tuning accuracy of two hybrid Transformer and CNN models, Segformer and EfficientViT, specifically within the realm of semantic segmentation tasks under conditions of integer-only quantization. Furthermore, LUT-based PLA units with varying degrees of precision are implemented using Verilog HDL, and their hardware performance, including metrics such as area and power dissipation, is benchmarked.

Advantages or improvement of the invention over prior art-(a) Improvement in Operator-Level Accuracy:

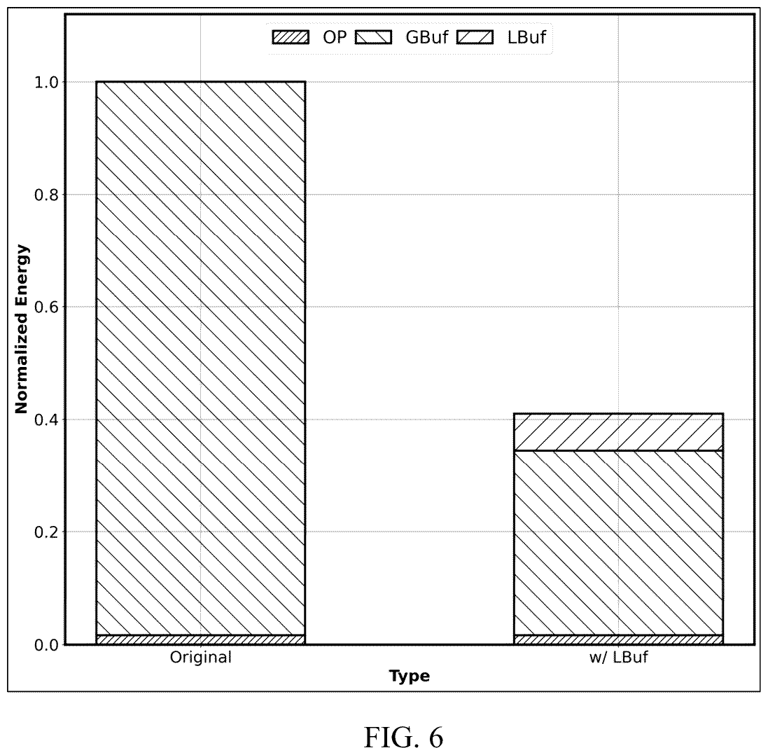

In the present invention, five prevalent non-linear functions utilized in the Transformer architecture and its variations are explored, namely: GELU, EXP, HSWISH, DIV, and RSQRT. Additionally, NN-LUT has been re-implemented, adhering to the training methodologies, and the slopes, intercepts, and breakpoints have been directly translated to match the precision level of GQA-LUT. To thoroughly assess the accuracy at the operator level with a focus on quantization awareness, the analysis of dequantized INT8 data with a step size increment of the scaling factor has been prioritized. Given that only GELU, EXP, and HSWISH are influenced by the scaling factor S, an in-depth comparison of the Mean Squared Error (MSE) for various values of S is provided in FIG. 6. It is evident that GQA-LUT with Rounding Mutation (RM) demonstrates consistently superior performance across different values of S in comparison to NN-LUT.

Advantages or improvement of the invention over prior art-(b) Improvement in Fine-tuning Model Accuracy:

In the present invention, fine-tuning accuracy is further evaluated on the Cityscapes dataset, a semantic segmentation benchmark with pixel-level annotations across 19 categories. Two Transformer models are focused on: Segformer-B0 at 1024×1024 resolution, using non-linear operators like EXP and GELU, and EfficientViT-B0 at 1920×1024 resolution, designed for edge devices with HSWISH and DIV operators. Both models undergo INT8 quantization using the LSQ method, forming the baseline. Utilizing the mean Intersection over Union (mIoU) metric for evaluation, the results in Table 1 and 2 show that the GQA-LUT with RM method minimally impacts fine-tuning accuracy, with losses of just 0.07% for Segformer-B0 and 0.02% for EfficientViT-B0, outperforming the NN-LUT approach with improvements of 1.07% and 0.88%, respectively.

TABLE 1
Fine-tuning mIoU of Segformer-B0 on Cityscapes

| Replacement* | NN-LUT | GQA-LUT w/o RM | GQA-LUT w/RM |
|---|---|---|---|
| None | 74.60% | 74.60% | 74.60% |
| EXP only | 73.88% | 74.31% | 74.59% |
| GELU only | 73.61% | 74.24% | 74.57% |
| DIV only | 74.15% | 74.37% | 74.58% |
| RSQRT only | 73.94% | 74.17% | 74.51% |
| Altogether | 73.46% | 74.28% | 74.53% |

*The non-linear function that is replaced by 8-Entry PLA

TABLE 2
Fine-tuning mIoU of EfficientViT on Cityscapes

| Replacement* | NN-LUT | GQA-LUT w/o RM | GQA-LUT w/RM |
|---|---|---|---|
| None | 74.17% | 74.17% | 74.17% |
| HSWISH only | 73.55% | 73.98% | 74.20% |
| DIV only | 73.21% | 73.30% | 74.08% |
| Altogether | 73.27% | 73.79% | 74.15% |

*The non-linear function that is replaced by 8-Entry PLA

Advantages or improvement of the invention over prior art-(c) Advantages of Hardware Performance

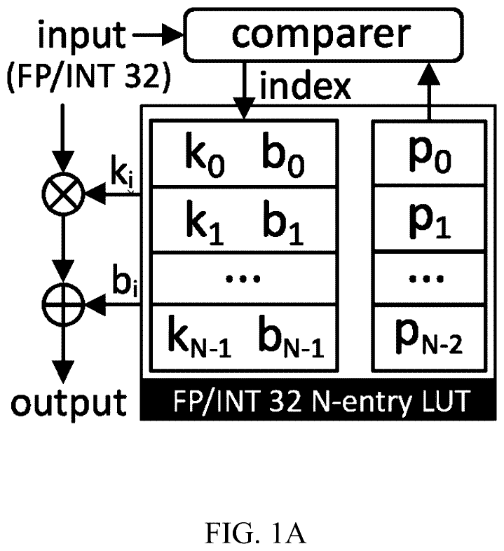

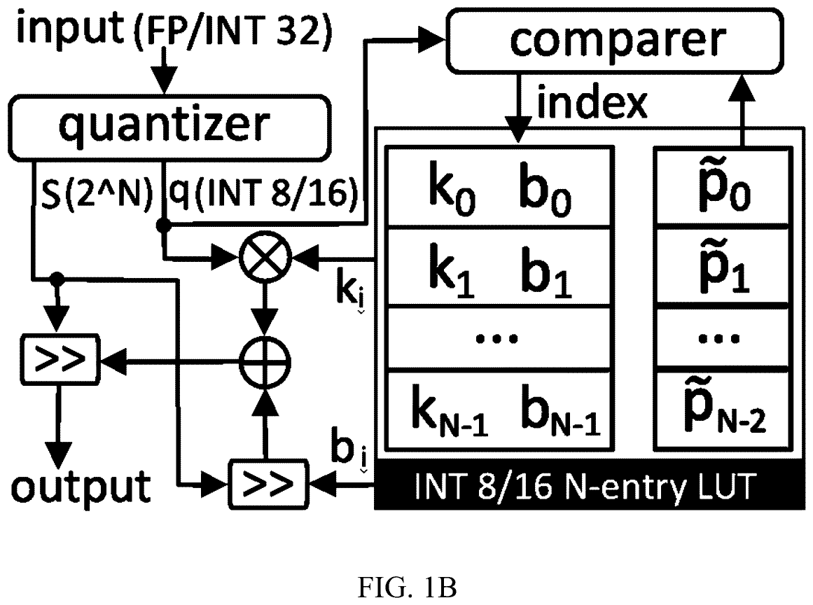

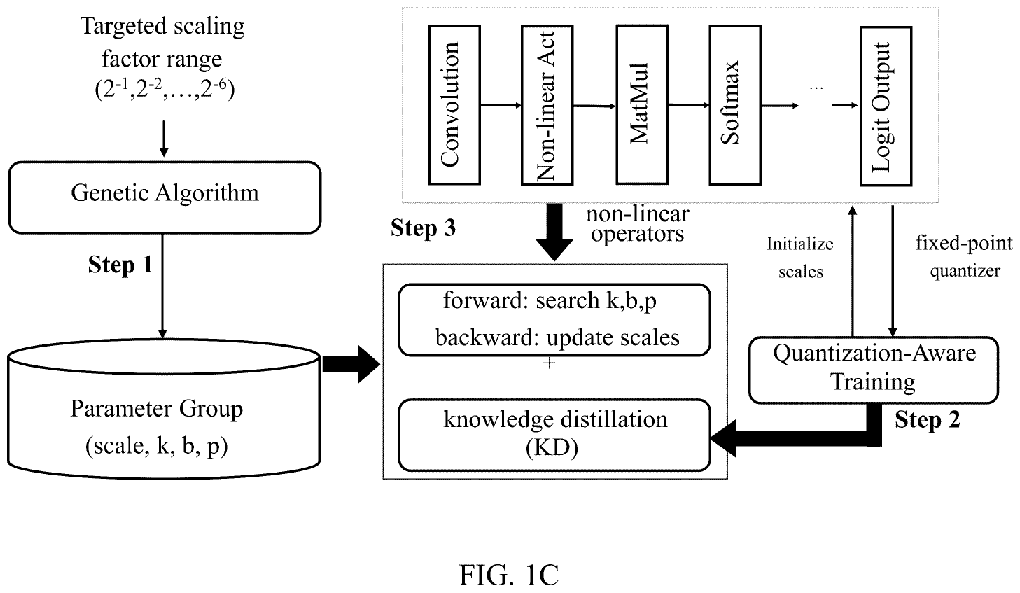

To further validate the necessity and advantages of GQA-LUT with low-bit precision (INT8), two types of hardware units are designed as depicted in FIGS. 1A and 1B using Verilog HDL. The area and power consumption metrics for each LUT-based unit are acquired through synthesis with Synopsys Design Compiler, leveraging 28-nm technology. For a balanced comparison, the operating frequency is standardized at 500 MHz across all units. The findings, presented in Table 3, indicate that an 8-entry INT8 LUT-based PLA occupies merely 961 um2, demonstrating significant area reductions of 81.3% and 81.7% compared to the high-precision FP32 and INT32 units, respectively. In terms of power efficiency, the INT8 configuration utilizes only 0.4 mW, leading to considerable power savings of 80.2% for FP32 and 79.3% for INT32. Furthermore, increasing the LUT size to 16 entries incurs about a 1.71-fold increase in area and a 1.95-fold increase in power consumption compared to the 8-entry INT8 setup. This underscores the importance of selecting a configuration with fewer entries and lower precision for PWL functions when adhering to integer-only quantization, highlighting its efficacy in optimizing hardware resource utilization and power efficiency.

TABLE 3
Hardware Costs under 28-nm Technology

| Precision* | Entry | Area(um²) | Power (mW) |
|---|---|---|---|
| INT8 | 8 | 961 | 0.40 |
| | 16 | 1640 | 0.78 |
| INT16 | 8 | 2080 | 0.85 |
| | 16 | 3521 | 1.47 |
| INT32 | 8 | 5243 | 1.93 |
| | 16 | 8040 | 3.14 |
| FP32 | 8 | 5135 | 2.02 |
| | 16 | 7913 | 3.47 |

The advantages of applying near-memory computing techniques to Softmax and LayerNorm with the GQA-LUT method are discussed, referring to the relative energy consumption of MAC and different types of SRAM.

FIG. 6 shows the normalized energy breakdown of computational energy (OP), GBuf r/w energy, and LBuf r/w energy by the original Softmax. The near-memory computing technique is beneficial for Softmax since it includes multiple rounds of buffer reading and writing. From FIG. 6, it can be concluded that the relative energy consumption of Softmax is reduced by 43.9% when applying LBuf.

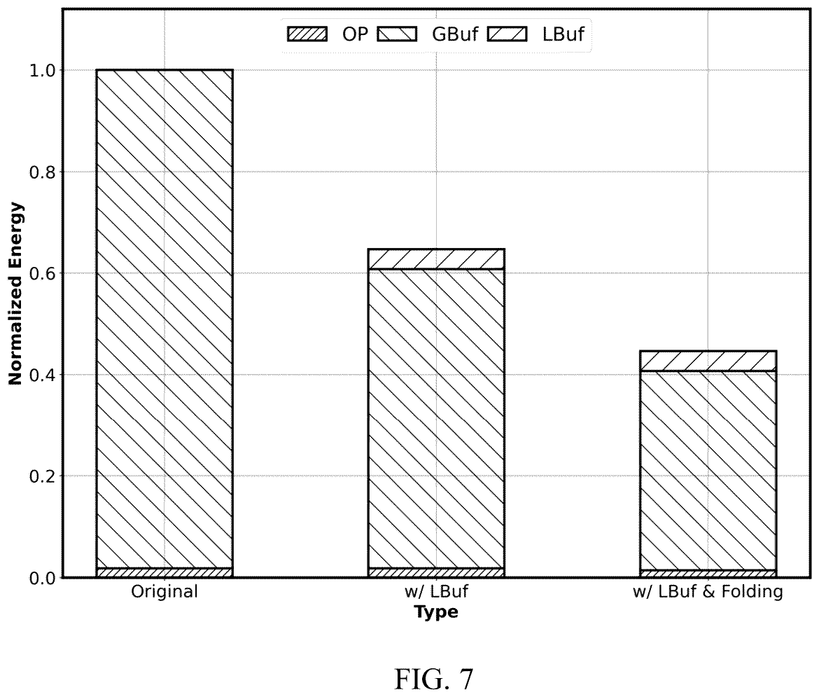

As shown in FIG. 7, LayerNorm with the near-memory computing technique, and further with folding arithmetic, indicates that applying near-memory computing yields an energy saving of 35.4%. Additionally, LayerNorm folding, which alleviates both the computational complexity and memory access burden by fusing the elementwise affine with universal convolution operations, leads to a considerable energy saving of 55.4%.

The following provides specific examples to illustrate the implementation of the present invention.

### Example 1: A LUT-Based PLA Using a Genetic Algorithm (GQA-LUT) and its Hardware Implementation

FIG. 1A illustrates the implementation of high-precision (FP32 or INT32) LUT-based PLA without input quantization in hardware; FIG. 1B illustrates the implementation of proposed low-precision (INT8 or INT16) LUT-based PLA with input quantization in hardware; and FIG. 1C provides a schematic diagram of the operation mechanics of the improved approximation method and architecture of the present invention.

Adopting PLA for a range of nonlinear operations, in conjunction with storing parameters in LUTs, has emerged as a broadly embraced strategy for boosting hardware efficiency. This methodology has been substantiated and supported by several significant studies in recent times. An N-entry LUT-based PLA can be formularized as follows:

$$PLA ( x ) = \{ \begin{matrix}{k}_{0} x + {b}_{0} , & if x < {p}_{0} \\ {k}_{1} x + {b}_{1} , & if {p}_{0} \leq x < {p}_{1} \\ ⋯ & \\ {k}_{N - 1} x + {b}_{N - 1} , & if x \geq {p}_{N - 2}\end{matrix} . \qquad ( 1 )$$

The parameters for an N-Entry PLA are stored in a LUT as illustrated in FIG. 1A. This setup allows for maintaining high accuracy thanks to the superior representation capability of FP/INT32-based LUT storage along with the input data. Nevertheless, challenges may emerge in scenarios that involve quantization with low-bit precision.

Quantization has become a favored approach for diminishing computational and memory overhead upon deployment on chips, as it facilitates inference using low-bit representations. The quantization function is defined as follows:

$$\tilde{x} = α \cdot {Q}_{k} ( x ) = α \cdot ⌊ Clip ( \frac{x}{α} , {Q}_{n} , {Q}_{p} ) ⌉ , \qquad ( 2 )$$

where Qₖ(·) represents the k-bit quantization function that compresses the high-precision input data x to low-bit INT-k by a scaling factor α. Specifically, the Qₖ(x) constrains

$$PLA ( x ) = \{ \begin{matrix}{k}_{0} x + {b}_{0} , & if x < {p}_{0} \\ {k}_{1} x + {b}_{1} , & if {p}_{0} \leq x < {p}_{1} \\ ⋯ & \\ {k}_{N - 1} x + {b}_{N - 1} , & if x \geq {p}_{N - 2}\end{matrix} . \qquad ( 1 )$$

within the range of [−2^{k-1}, 2^{k-1}−1] or [0, 2^{k}−1] for the signed and unsinged data, bouded by Qₙ and Qₚ. The dequantized data \tilde{x} can be retrieved through re-scaling Qₖ(x) by α which is determined either using the min-max technique or the learnable alternative. Generally, the non-linear function is linearly inseparable, e.g., exp(α·Qₖ(x))≠α·ep(Qₖ(x)). The approximation can be directly applied on x but lacks universality due to the diverse dataflow. As for the PLA method, it can bring separability to the non-linear function by its inherence of PLA (α·Qₖ(x))=α·PLA(Qₖ(x)), whereas current PLA-based works only focus on optimizing PLA(α·Qₖ(x)), their arithmetics are still in high-precision FP/INT format. The PLA offers a distinctive advantage that allows us to execute PWL operations directly on quantized data Qₖ(x) while segregating the scaling factor α.

In addition, the scaling factor is set as a power-of-two. This is achieved by rounding the logarithmic value of a learnable parameter a to its nearest integer. Then, the scaling factor can be derived by α*=2^{[log}^{₂}^{^{α}}^{]}. This power-of-two adjustment of α is designed to streamline the process of PLA when meeting with quantization, since all the operations can be done by a shifter in hardware if the scaling factor is in power-of-two. Based on the above analyses, a quantization-aware LUT-based PLA is proposed in FIG. 1B.

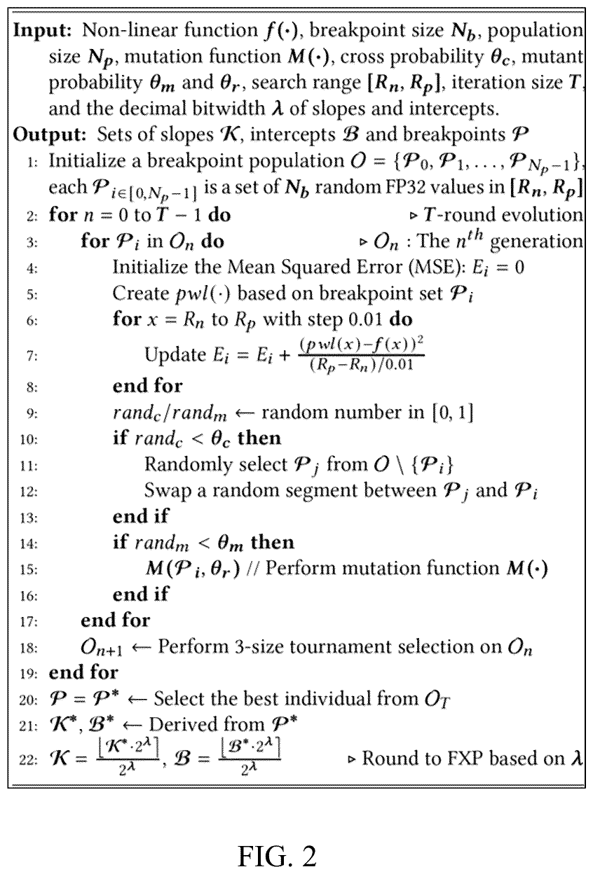

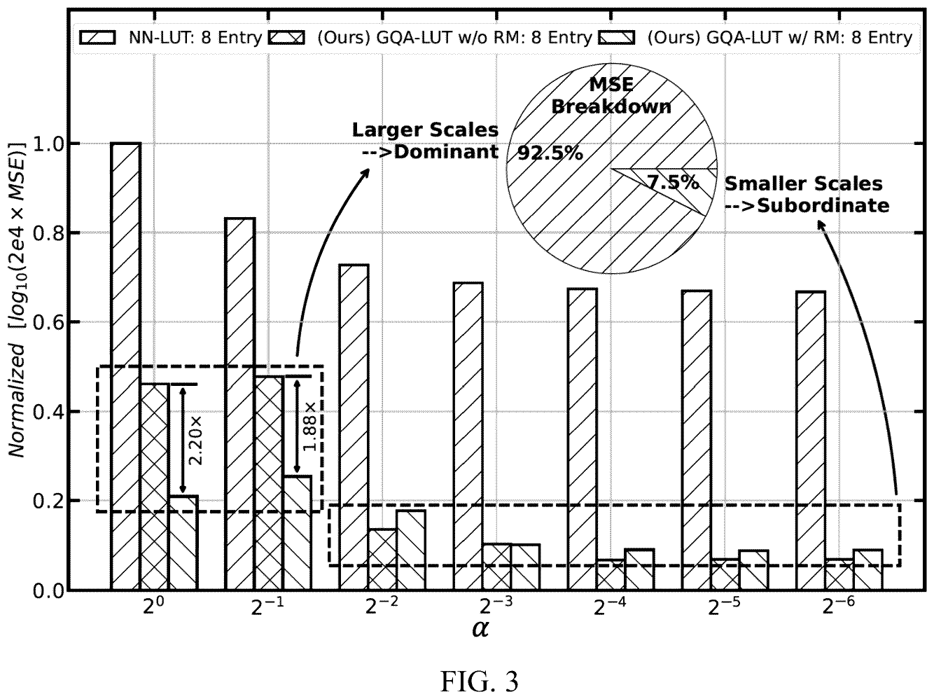

However, the performance of LUT-based PLA highly depends on the selection of breakpoints pᵢ, slopes kᵢ, and intercepts bᵢ, where i represents the index of each entry. To better take into consideration of the quantization effect where previous neural network-based methods fail, a genetic PLA algorithm is proposed in this invention which is described in FIG. 2. The core concept involves creating a population composed of various individuals, which represent the breakpoints pᵢ of different piecewise linear functions. These individuals undergo stochastic processes of crossover and mutation to foster diversity and discover novel solutions. Crossover involves the exchange of segments between pairs, whereas mutation incorporates a normal distribution of noise to introduce variability. The individual that demonstrates the highest fitness, identified by the lowest mean squared error (MSE) in approximating the nonlinear function ƒ(·), is then selected. This process, embodied by the GQA-LUT, reflects the principles of natural selection, with MSE acting as the selection criterion. To facilitate storage and computation in a compact INT format, a direct method where the optimal sets of slopes and intercepts are converted from FP32 to F×P values is adopted, utilizing a specified decimal bitwidth λ. Concurrently, the breakpoints are quantized as depicted in Equation (2). The selection of λ is guided by the search interval [Rn, Rp] for a given ƒ(·). When comparing the accuracy of an 8-entry GQA-LUT and an NN-LUT using the same FXP conversion technique for approximating GELU, as shown in FIG. 3, it is observed that the GQA-LUT outperforms the NN-LUT across all scaling factors.

### Example 2—a Mutation Algorithm that Incorporates Quantization Effects into the Above GQA-LUT

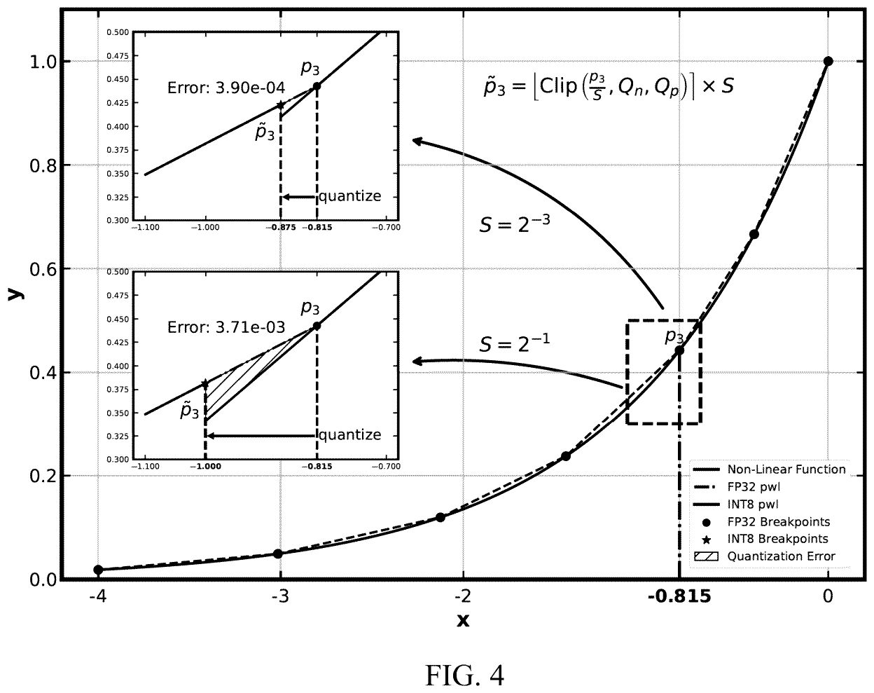

A detailed analysis of the MSE for GQA-LUT indicates that its primary challenge lies in managing large a values, as shown in FIG. 3. In particular, scaling factors less than 2\hat{ }-2 account for more than 90 percent of the total error, underscoring a significant limitation in handling large a efficiently. To understand why approximation errors are more pronounced at higher values of a, the approximation curves for the exponential function (EXP) is analyzed, as shown in FIG. 4. When a breakpoint p is quantized to a specific integer value as per Equation (2), the resulting approximation error exhibits variability across different scaling factors α. Notably, at higher α values, the breakpoint is prone to significant shifts, leading to noticeable approximation offsets-an effect we refer to as breakpoint deviation. On the other hand, a lower a tends to result in minimal deviation, effectively reducing the error. This insight underscores the limitations of employing a straightforward FXP conversion for GQA-LUT, particularly at higher scaling factors, where breakpoint deviation becomes markedly more significant.

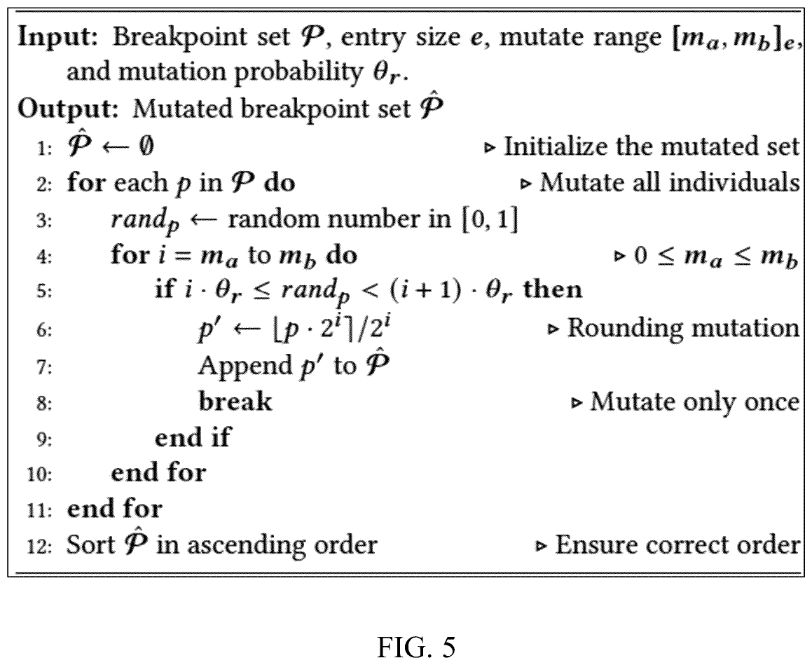

To address this challenge, an approach termed Rounding Mutation (RM), is introduced, which is elaborated in FIG. 5. The RM technique conceptualizes the quantization of breakpoints as a stochastic mutation, where quantization occurs randomly across different scales a, impacting each element within a set of breakpoints throughout their evolutionary trajectory. In the context of GQA-LUT, the traditional mutation function, which is based on normally distributed noise, is replaced with the proposed RM method, while still maintaining the straightforward FXP conversion for slopes and intercepts. As illustrated in FIG. 3, incorporating the RM strategy into GQA-LUT significantly reduces the MSE for large values of a. Although there is a slight increase in MSE for smaller a values, where the error was initially low, this rise is negligible and can be practically overlooked.

### Example 3—a Near-Memory Computing Hardware Implementation that Utilizes the Above Examples for the Quantized Softmax and Folding-Based LayerNorm

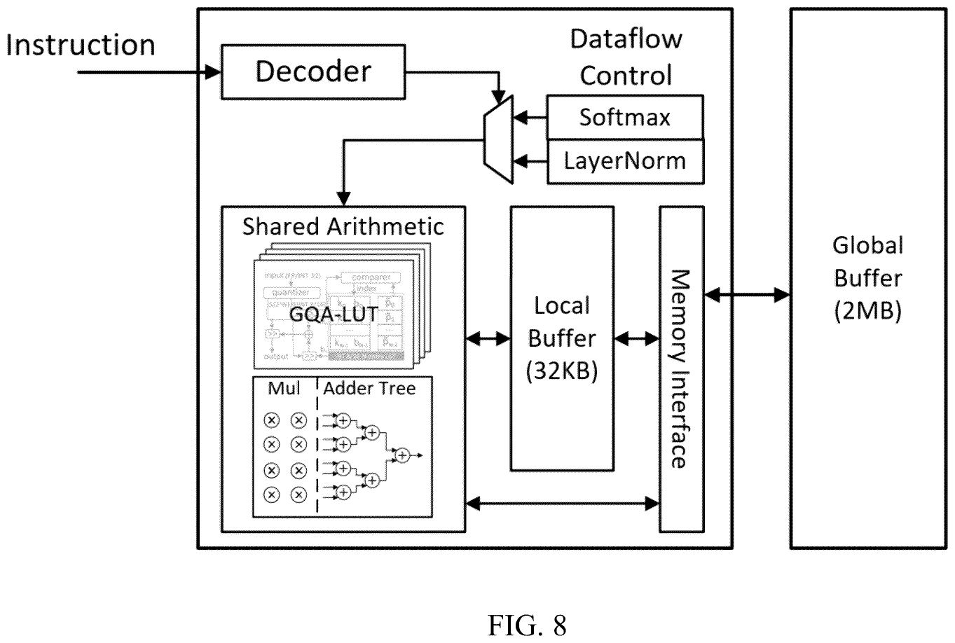

Since Softmax and LayerNorm have similar memory access regularities like token-based memory read and write, they can be equipped together as a special computation unit (SPU). SPU can be embedded to an AI accelerator. As shown in FIG. 8, SPU uses an instruction set and utilizes a decoder structure to determine the operation and memory address. Softmax and LayerNorm submodules share a local buffer which is smaller than 64 KB for near-memory computing, reducing the memory access energy and latency due to replicate memory access needed in both operations. Thanks to the configurability of GQA-LUT, both operations share several INT8 GQA-LUT modules for PLA of exponent, square-root, and reciprocal.

Besides, we propose LayerNorm folding which fuses the LayerNorm parameters with weight and bias of consecutive convolution layers to reduce memory and computation overhead. Consider a pointwise convolution layer connected after a LayerNorm layer for instance, the input of convolution layer is

$${x}_{ik} = {l}_{ik} {γ}_{k} + {β}_{k} , \qquad ( 3 )$$

where i denotes the i^{th} token, k denotes the kth input channel among totally C input channels. l is the initial LayerNorm without elementwise affine transformation. γₖ and βₖ is the weight and bias of affine transformation. The output of the convolution layer is:

$${y}_{ij} = ( {\sum }_{k = 1}^{c} {x}_{ik} {w}_{jk} ) + {b}_{j} , \qquad ( 4 )$$

where j denotes the j^{th} filter of the convolution layer after LayerNorm. Then, substituting xᵢₖ with LayerNorm parameters to obtain:

$${y}_{ij} = ( {\sum }_{k = 1}^{c} ( {l}_{ik} {γ}_{k} + {β}_{k} ) {w}_{jk} ) + {b}_{j} , \qquad ( 5 )$$

The eqaution can be organized to

$${y}_{ij} = ( {\sum }_{k = 1}^{c} {l}_{ik} {γ}_{k} ) {w}_{jk} + ( {b}_{j} + {\sum }_{k = 1}^{c} {β}_{k} {w}_{jk} ) , \qquad ( 6 )$$

Therefore, it is to deduce that the folding weight for convolution is:

$${w}_{jk}^{′} = ( {\sum }_{k = 1}^{c} {l}_{ik} {γ}_{k} ) {w}_{jk} , \qquad ( 7 )$$

And, the folding bias is

$${b}_{j}^{′} = {b}_{j} + {\sum }_{k = 1}^{c} {β}_{k} {w}_{jk} , \qquad ( 8 )$$

LayerNorm folding reduces the elementwise affine transformation which requires weight buffer access and MAC operation. Therefore, SPU no longer requires IO for weight buffer access, alleviating placement burden and timing issue.

To accelerate Softmax or LayerNorm, SPU first receives an instruction from the host processor or stage controller, then executes it according to dataflow controller. Only the first memory read access and the final write back process need to access GBuf, while the others are completed in SPU with LBuf. All computations are performed by shared arithmetic to maximize resource reuse by muxers.

### Example 4.1: Energy Efficiency Analysis

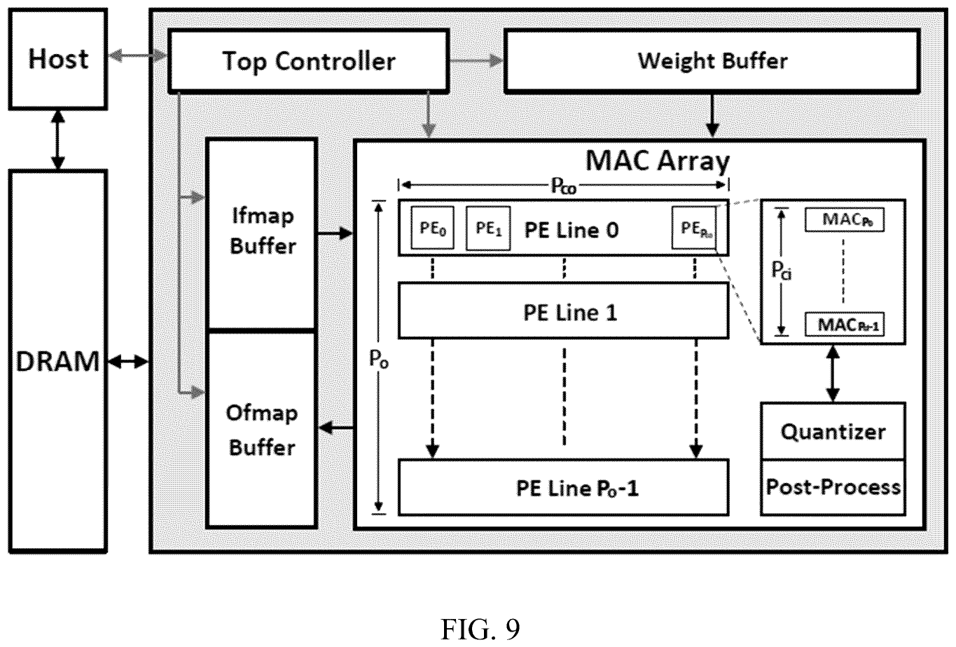

In the realm of DNN accelerators, a key factor is energy efficiency in terms of operations/watt, significantly influenced by precision, layer size, dataflow, and architecture. In the present invention, energy efficiency in a typical DNN accelerator system is examined using methodologies as shown in FIG. 9. This system includes a multiply-accumulate (MAC) array, on-chip SRAM, off-chip DRAM, and a top controller. The MAC array is organized based on Po, Pci, and Pco, which define parallelism in the output feature map, input channels, and output channels, respectively. The on-chip SRAM comprises a 128 KB input/output buffer and a 64 KB weight buffer, while the off-chip DRAM capacity is assumed sufficient, and the top controller manages module configuration. The total energy cost Etotal is:

$${E}_{total} = {N}_{d} \cdot {E}_{dram} + {N}_{s} \cdot {E}_{sram} + {N}_{m} \cdot {E}_{mac} \qquad ( 9 )$$

where the Edram, Esram, and Emac represent the energy cost for each access to DRAM and SRAM, as well as for a single MAC operation, respectively. The N_{d}, Nₛ, and Nm correspond to the total number of accesses to DRAM and SRAM, and the overall count of MAC operations utilized. Energy cost values are taken with E_{dram}=162.5 pJ/byte, Eₛᵣₐₘ=12.5 pJ/byte and E_{mac}=0.3 pJ/MAC under 45 nm and 0.9V for following analysis. Since the number of MACs for a specific DNN is constant, the energy efficiency largely depends on E_{dram/sram}.

In the analytical framework according to some known studies, the weight, activation, and PSUMs are all stored in 16-bit fixed-point format. However, PSUMs might require higher precision such as INT32 in certain integer-only quantized DNN accelerators. To accommodate this variation, the framework is revised by introducing a precision factor as below:

$${N}_{d / s} = Si \cdot {N}_{d / s}^{i} + {S}_{w} \cdot {N}_{d / s}^{w} + β \cdot {S}_{o} \cdot {N}_{d / s}^{p} + {S}_{o} \cdot {N}_{d / s}^{o} \qquad ( 10 )$$

The total number of access to DRAM/SRAM for ifmap, weight, PSUM, and ofmap is defined as Nⁱ_{d/s}, N^{w}_{d/s}, N^{p}_{d/s} and N^{o}_{d/s}, with Sᵢ, S_{w} and Sₒ indicating the size of ifmap, weights, and ofmap. The β is the ratio of PSUM precision to that of feature map/weight. For instance, β would be 4 if PSUM is in INT32 for an INT-8 DNN. In the present invention, the focus is merely placed on INT-8 DNN with WS or IS, as the OS does not encounter issues with the precision of PSUM.

Regarding Weight Stationary, the WS-based accelerator loads ifmap tiles to update the PSUMs via reusing Pci×Pco kernel weights, and the ofmap tile is generated after finishing PSUM accumulation. According to this, the components of Ns can be derived as:

$${N}_{s}^{i} = \{ \begin{matrix}1 + ⌈ \frac{{C}_{o}}{{P}_{co}} ⌉ , {\tilde{s}}_{i} < {B}_{i} \\ 2 ⌈ \frac{{C}_{o}}{{P}_{co}} ⌉ , {\tilde{s}}_{i} \geq {B}_{i}\end{matrix} , {N}_{s}^{w} = 1 + ⌈ \frac{{H}_{o}}{{P}_{oh}} ⌉ ⌈ \frac{{W}_{o}}{{P}_{ow}} ⌉ {N}_{s}^{p} = \{ \begin{matrix}2 ( ⌈ \frac{{C}_{i}}{{P}_{ci}} ⌉ - 1 ) , {\tilde{s}}_{p} < {B}_{o} \\ 4 ( ⌈ \frac{{C}_{i}}{{P}_{ci}} ⌉ - 1 ) , {\tilde{s}}_{p} \geq {B}_{o}\end{matrix} , {N}_{s}^{o} = 2 \qquad ( 11 )$$

where Ci and Co represent the dimensions of input and output channels, the Bi and Bo indicate the capacities of ifmap and ofmap in bytes. The ofmap's height and width are denoted as Hₒ and Wₒ. Besides, the input tile size \tilde{S}ᵢ is enlarged based on output tiles, kernels, and strides. The \tilde{S}ₚ is the size of tiled PSUM calculated as β×Pₒ×P_{co}, where Pₒₕ and P_{ow} are the height and width of the output/PSUM tile, constrained by Pₒ=Pₒₕ×P_{ow}.

If exceeding the Bi or Bo, extra read to both the SRAM and DRAM occur, the Ni/w/plod is defined as:

$${N}_{d}^{i} = \{ \begin{matrix}1 , {\tilde{s}}_{i} < {B}_{i} \\ ⌈ \frac{{C}_{o}}{{P}_{co}} ⌉ , {\tilde{s}}_{i} \geq {B}_{i}\end{matrix} , {N}_{s}^{w} = 1 ; \\ {N}_{d}^{p} = \{ \begin{matrix}0 , {\tilde{s}}_{p} < {B}_{o} \\ 2 ( ⌈ \frac{{C}_{i}}{{P}_{ci}} - 1 ) , {\tilde{s}}_{p} \geq {B}_{o}\end{matrix} , {N}_{d}^{o} = 1 \qquad ( 12 )$$

Regarding Input Stationary, in contrast, the IS-based accelerator keeps the input tiles stationary within the MAC array's registers, facilitating their reuse by weights to update the PSUMs in the output buffer. Similarly, the Ni/w/p/os is summarized as below:

$${N}_{s}^{w} = \{ \begin{matrix}1 + ⌈ \frac{{H}_{i}}{{P}_{ih}} ⌉ ⌈ \frac{{W}_{i}}{{P}_{iw}} ⌉ , {S}_{w} < {B}_{w} \\ 2 ⌈ \frac{{H}_{i}}{{P}_{ih}} ⌉ ⌈ \frac{{W}_{i}}{{P}_{iw}} ⌉ , {S}_{w} \geq {B}_{w}\end{matrix} , {N}_{s}^{i} = 2 \\ {N}_{s}^{p} = \{ \begin{matrix}2 ( ⌈ \frac{{C}_{i}}{{P}_{ci}} ⌉ - 1 ) , \frac{{C}_{o}}{{P}_{co}} \cdot {\tilde{s}}_{p} < {B}_{o} \\ 4 ( ⌈ \frac{{C}_{i}}{{P}_{ci}} ⌉ - 1 ) , \frac{{C}_{o}}{{P}_{co}} \cdot {\tilde{s}}_{p} \geq {B}_{o}\end{matrix} , {N}_{s}^{o} = 2 \qquad ( 13 )$$

the weight buffer size is denoted by Bw and the height and width of the enlarged ifmap are Hi and Wi, respectively. Besides, the ifmap tile is shaped by Pih and Piw following Pi=Pih×Piw. Notably, the PSUM of IS is larger than that of WS since the ifmap tile needs to be reused by weights along the whole Co. Consequently, the \tilde{S}p is scaled by Co/Pco. The Ni/w/plop for DRAM is derived as:

$${N}_{d}^{w} = \{ \begin{matrix}1 , {S}_{w} < {B}_{w} \\ ⌈ \frac{{H}_{i}}{{P}_{ih}} ⌉ ⌈ \frac{{W}_{i}}{{P}_{iw}} ⌉ , {S}_{w} \geq {B}_{w}\end{matrix} , {N}_{d}^{i} = 1 \\ {N}_{d}^{p} = \{ \begin{matrix}0 , \frac{{C}_{o}}{{P}_{co}} \cdot {\tilde{s}}_{p} < {B}_{o} \\ 2 ( ⌈ \frac{{C}_{i}}{{P}_{ci}} ⌉ - 1 ) , \frac{{C}_{o}}{{P}_{co}} \cdot {\tilde{s}}_{p} \geq {B}_{o}\end{matrix} , {N}_{s}^{o} = 1 \qquad ( 14 )$$

### Example 4.2: Integer-Only Quantization

Quantization has emerged as an effective strategy to alleviate computational and memory overheads, particularly advantageous for deployments on hardware accelerators, and can be expressed as:

$$\tilde{x} = α \cdot {Q}_{k} ( x ) = α \cdot [ Clip ( \frac{x}{α} , {Q}_{n} , {Q}_{p} ) ] \qquad ( 15 )$$

where Qₖ(·) represents the k-bit quantization function that compresses the high-precision input data to low-bit INT-k by a scaling factor α. Specifically, the Qₖ(x) constrains xα within the range [−2^{k-1}, 2^{k-1}−1] or [0, 2^{k-1}] for the signed and unsigned data, bounded by Qₙ and Qₚ. The dequantized \tilde{x} can be retrieved through re-scaling Qₖ(x) by a which is determined either using the minmax technique or the learnable alternative that is more favored for its effectiveness. In particular, the quantization can be categorized into integer-only and simulated variants, characterized by the former merely containing low-cost integer arithmetics, while the latter relies largely on high-precision dequantized data. In this work, integer-only quantization is chosen, where the α for both weights and activations/PSUMs are obtained by LSQ and forced to dyadic and power-of-two format via straight through estimator (STE), respectively.

### Example 4.3: Partial Sum Quantization

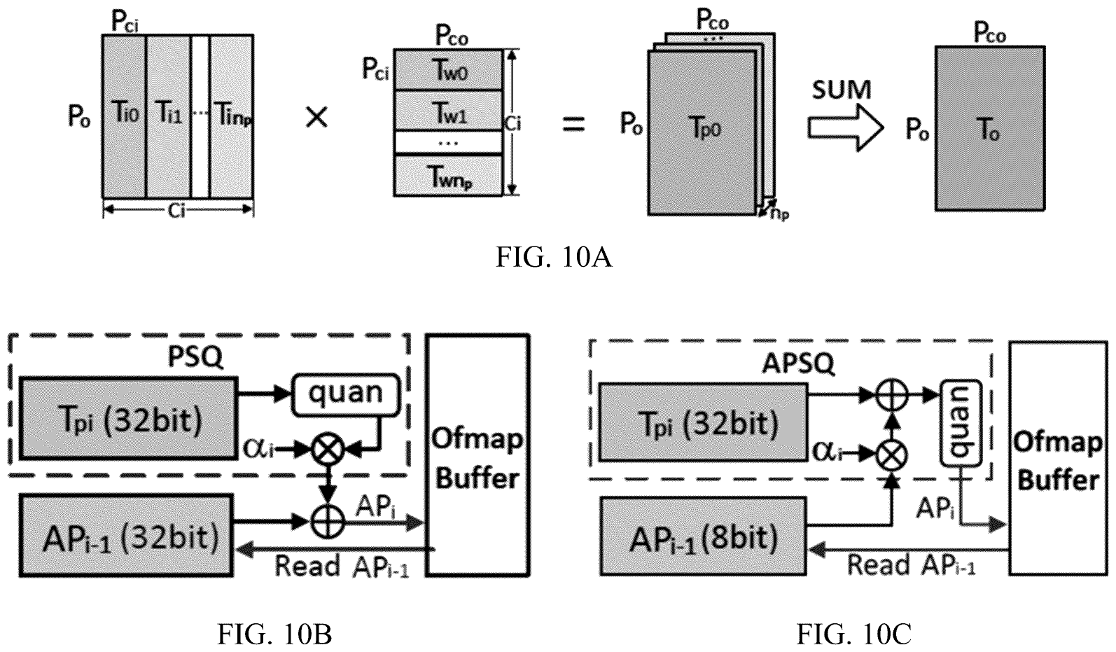

Tile-based computation (TBC) is a primary method in DNN accelerators due to computational limitations. This technique frequently involves additive interactions with PSUMs to produce the final output tile. Defining Tᵢ, T_{w}, Tₚ, and Tₒ as the tiles for ifmap, weight, PSUM, and ofmap severally, an example of pointwise convolution with TBC can be illustrated in FIG. 10A. The ofmap tile Tₒ is derived from the accumulation of multiple PSUMs, generated by multiplying elements within Ti and Tw. Thus, the TBC could be formulated as follows:

$${T}_{o} = {\sum }_{i = 0}^{{n}_{p} - 1} {T}_{pi} , {n}_{p} = ⌈ \frac{{C}_{i}}{{P}_{ci}} ⌉ \qquad ( 16 )$$

where nₚ signifies the number of PSUM tile Tₚᵢ for 0≤i≤nₚ−1.

Although TBC ensures computational efficiency, the necessity for high precision in PSUMs can still introduce overheads in certain CIM designs. Thus, they both propose PSUM quantization (PSQ), depicted in FIG. 10B and summarized by:

$${AP}_{j} = {\sum }_{i = 0}^{j} {α}_{i} \cdot {Q}_{k}^{i} ( {T}_{p i} ) , {T}_{o} = A {P}_{j} + {\sum }_{i = j + 1}^{{n}_{p} - 1} {α}_{i} \cdot {Q}_{k}^{i} ( {T}_{pi} ) \qquad ( 17 )$$

where each Qₖ(·) and a are annotated with a superscript correlating to its PSUM. APj represents the additive sum after the jth PSUM tile Tₚⱼ. The above equation and FIG. 10B reveal that APⱼ's precision is higher than that of Qₖ(Tₚ) due to additive addition, which results in notably higher energy costs for PSUM.

### Example 5.1: Additive Partial Sum Quantization

In view of the recent PSQ methods failing short of addressing the energy issue associated with high-precision PSUMs, which stems from the need to accumulate several dequantized PSUMs to generate a new one, which inevitably leads to the rebirth of high-precision PSUMs frequently, to achieve low-bit memory accesses across all PSUMs, the accumulation process should be prior to the quantization. Accordingly, a novel additive PSUM quantization approach termed APSQ is proposed herewith, detailed as follows:

$${T}_{o} = {AP}_{{n}_{p} - 1} , {AP}_{i} = {Q}_{k}^{i} ( {T}_{pi} + {α}_{i - 1} \cdot {AP}_{i - 1} ) , \\ for 1 \leq i \leq {n}_{p} \qquad ( 17 )$$

within the APSQ, each APi is recursively determined by applying Qik to the sum of Tpi and the preceding additive PSUM APᵢ₋₁, applicable for 1≤i<np and it is depicted in FIG. 10C. The initial additive PSUM APO is set as Q⁰ₖ(Tₚ₀). The output tile Tₒ is derived upon completing the quantization of the final PSUM. Consequently, Tₒ can be succinctly expressed as APnₚ₋₁. Notably, the APSQ also subjects the early PSUM to multiple quantization recurrently even though facilitating low-bit memory access for PSUMs. Take Tp₀ as an example, it encounters np quantizers in the journey of accumulation to eventually become Tₒ.

### Example 5.2: Groping Strategy

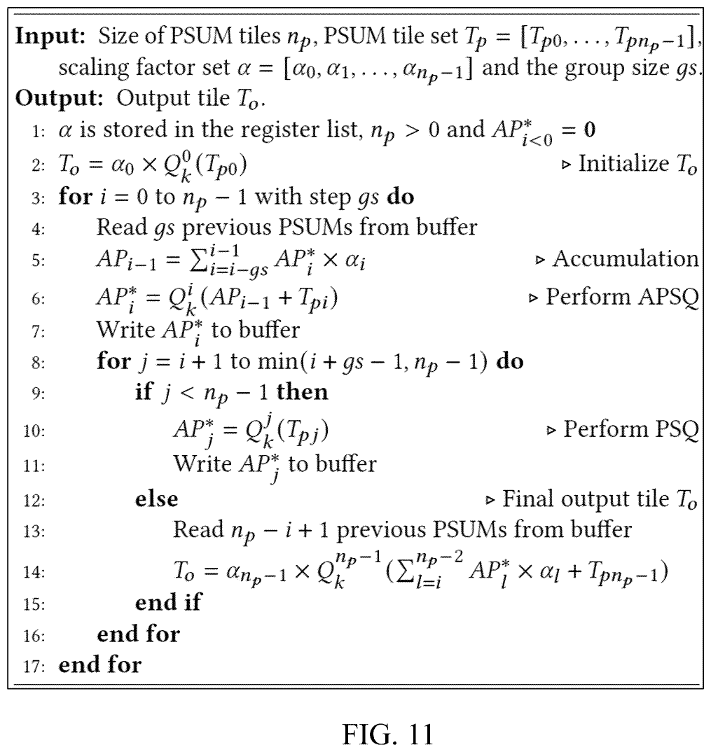

As previously discussed, engaging in multiple quantization often results in poor performance. To address this issue, lowering the frequency of quantization becomes crucial as it can reduce the extra rounding error for the early PSUM. Building on this insight, we proposed a grouping strategy that combines APSQ with PSQ detailed in the algorithm in FIG. 11.

It begins by partitioning the PSUM tile set into groups of size gs. In each group, APSQ is applied just once, focusing on the accumulation of current input PSUM tile added with the gs dequantized PSUM tiles via PSQ from the last group. The grouping strategy keeps the total memory read and write operations unchanged, but it consolidates the PSQ reads into the input of the next group's APSQ, resulting in a modest increase in the PSUM storage size. However, this increase is typically negligible due to the small size of the PSUM tile. Besides, the extra count of quantization is formulated as:

$${N}_{eq} = {\sum }_{a = 0}^{{n}_{p} - 1} [ a mod gs = \vert 0 or a = {n}_{p} - 1 ] \qquad ( 18 )$$

where [condition] is the indicator function which is equal to 1 when the condition is satisfied, and 0 otherwise. Owing to the grouping strategy, an increase in the gs can diminish the total count of extra quantization in the overall process.

### Example 5.3: Floating-Point Regularization

To further improve the accuracy of the aforementioned methods, a floating-point regularization (FPR) strategy is introduced. It computes the L2-norm as a measure of discrepancy between the floating-point inference results and the outputs obtained from APSQ/PSQ grouping strategy. The FPR is integrated during the training phase, directing the APSQ and PSQ toward alignment with accurate floating point results which can be formulated as:

$${ℒ}_{FPR} = {\sum }_{i = 0}^{{n}_{o} - 1} {‖ {T}_{oi}^{r} - {T}_{oi}^{q} ‖}_{2} \qquad ( 18 )$$

where Tₒᵢ^{r} and Tₒᵢ^{q} denote the i^{th} output tiles determined by floating point computation and grouping strategy, respectively. The symbol no represents the total number of output tiles, and ∥·∥₂ signifies the computation of the L₂-norm. The FPR aims at aligning the quantized PSUMs closely with that in floating-point. Also, knowledge distillation (KD) is utilized, a technique prevalent in quantization, using the floating-point model as a teacher. The overall loss is defined as L=L_{TASK}+λₖL_{KD}+λᵣL_{FPR}, with λₖ and λᵣ as the weighting factor for the KD and FPR losses, and LTASK represents the loss for a certain task such as cross-entropy loss in semantic segmentation.

### Example 6.1: Experimental Setup

In this section, it is to focus on a challenging semantic segmentation task, specifically targeting the Cityscapes dataset that depicts urban scenes across 19 classes and contains 2,975 images for training, 500 for validation, and 1,525 for testing. Additionally, the provided investigation encompasses two models: Segformer-B0, which employs a traditional Transformer architecture with vanilla attention, and EfficientViT-B0, a hybrid model that combines massive convolutions with linear attention. Integer-only quantization-aware training (QAT) is initially conducted in conjunction with a full-precision teacher model executing knowledge distillation (KD) to obtain the baseline models. Subsequently, a second phase of KD is performed, wherein the previously quantized network, incorporated with APSQ or PSQ, replaces the student model. Notably, the standard mean intersection over union (mIoU) is utilized as the evaluation metric in the experiments.

The setup of the analytical DNN accelerator, as depicted in FIG. 9, begins with the allocation of memory buffers: 128 KB each for the input feature map (ifmap) and output feature map (ofmap), and 64 KB for the weight buffer, whereas the off-chip DRAM is assumed to be sufficient. In the configuration of the MAC array, the parallelisms are organized to Po=16, Pci=8, and Pco=8 which determine the access times to SRAM and DRAM, thereby affecting the energy cost. The Pci and Pco also decide the number and size of PSUM in TBC as illustrated in FIG. 9 respectively, while they could be much larger in some CIM designs such as Pci/co=128.

### Example 6.2: Accuracy Analysis

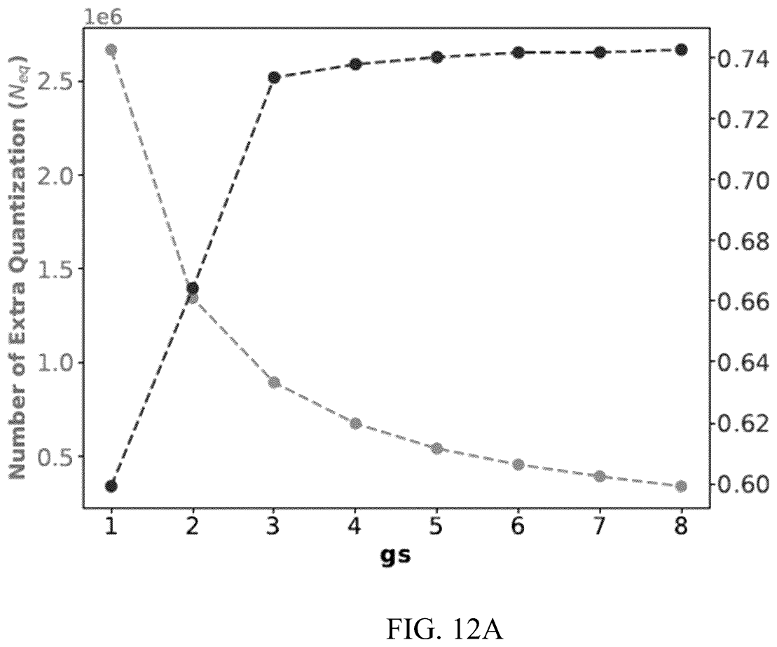

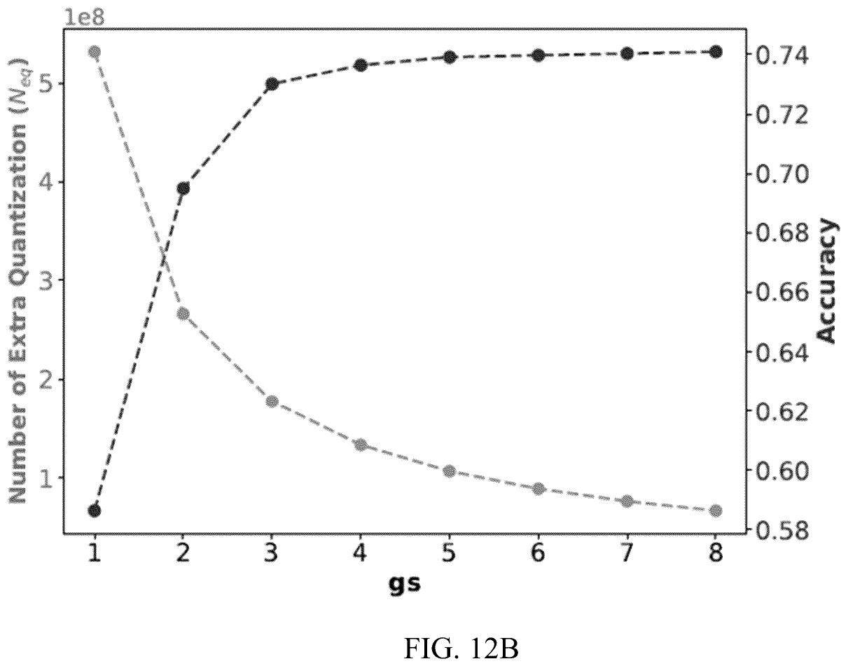

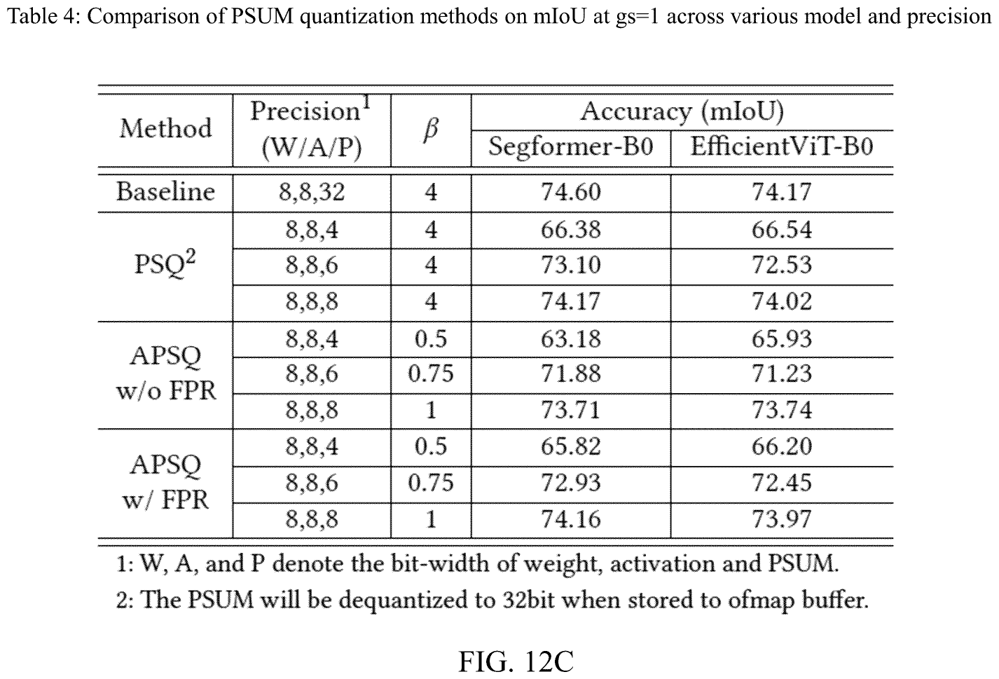

As mentioned above, applying APSQ to all PSUMs, which is the same as a grouping strategy with gs=1, significantly degrades performance due to enormous extra quantization on each PSUM. To explore this hypothesis, we conducted an accuracy assessment across different gs sizes as shown in FIGS. 12A and 12B under INT-8 quantization for all weights, activations, and PSUMs. The results clearly show that at gs=1, the accuracy suffers greatly, indicating that APSQ alone is insufficient. Furthermore, increasing gs gradually restores accuracy and the count of extra quantization is concurrently reduced.

Thus, there exists a pronounced correlation between the group size and the extent of extra quantization of PSUMs, with a larger group size being synonymous with superior performance. The model accuracy is further evaluated on various PSUM bit-widths with a fixed gs=6, as presented in Table 4 of FIG. 12C. The results reveal that APSQ can effectively reduce the precision factor β, and its performance can be enhanced when coupled with FPR techniques. Compared to the baseline of Segformer-B0 and EfficientViT-B0, the mIoU only drops by 0.44% and 0.20% when all the convolution, attention, and matrix multiplication are equipped with INT8 APSQ under the FPR strategy, demonstrating minimal impact on the accuracy.

### Example 6.3: Energy Analysis

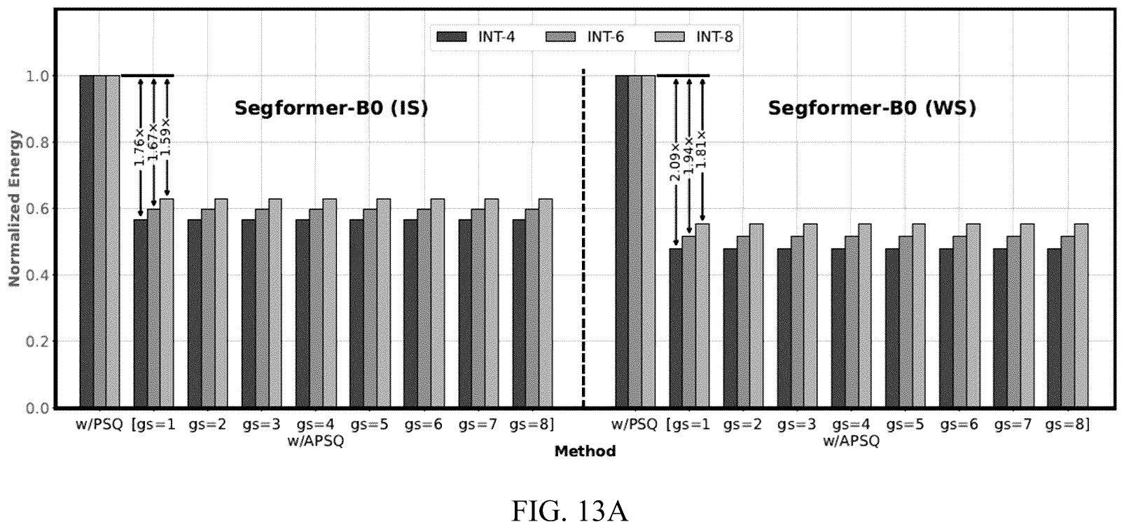

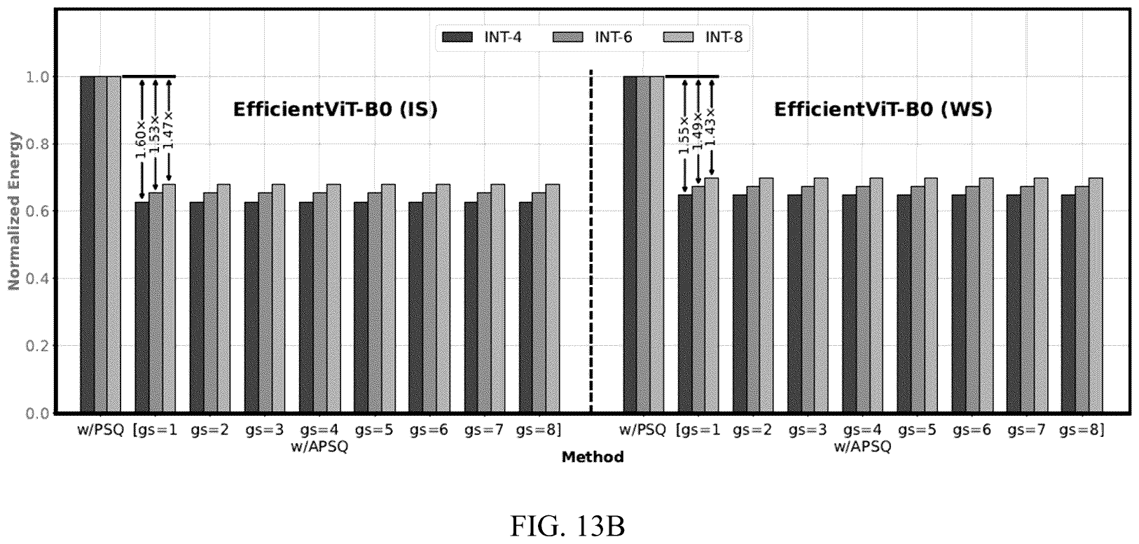

In continuation of the prior analyses on accuracy, we perform an energy costs evaluation associated with different PSUM precision and gs. As depicted in FIGS. 13A and 13B, there is a discernible trend that lower PSUM precision correlates with reduced energy costs, and the energy savings for precision levels under 8 bits are marginal, suggesting an inflection point where further precision reduction does not yield significant energy benefits. Compared to the INT8 APSQ, both Segformer-B0 and EfficientViT-B0, when equipped with PSQ, demonstrate notably higher energy costs, being 1.59× and 1.47× higher in IS, and 1.81× and 1.43× higher in WS, respectively. As a result, the INT8 APSQ yields an energy savings of 30˜45%. The superior performance of INT8 APSQ is attributed to its capacity for storing PSUMs in low-bit formats, a feature absent in PSQ which also demonstrates that INT8 is an adequate precision level for APSQ. The results in FIGS. 13A and 13B also indicate that variations in gs negligibly affect energy consumption. It is in harmony with the insights from above, which assert that increasing gs does not proportionally increase memory read/write operations, which are closely tied to energy consumption. Consequently, in the context of APSQ, it is the precision of the PSUM that predominantly dictates energy, while gs has a more significant effect on accuracy as previously discussed, positioning it as a parameter for exploration.

### Example 6.4: Design Space Exploration

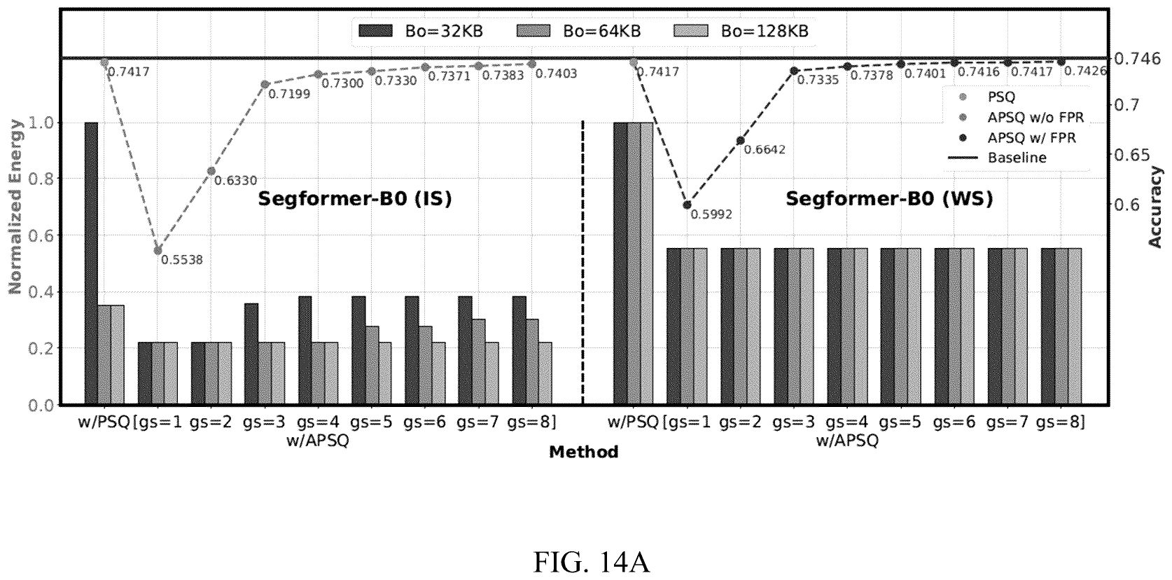

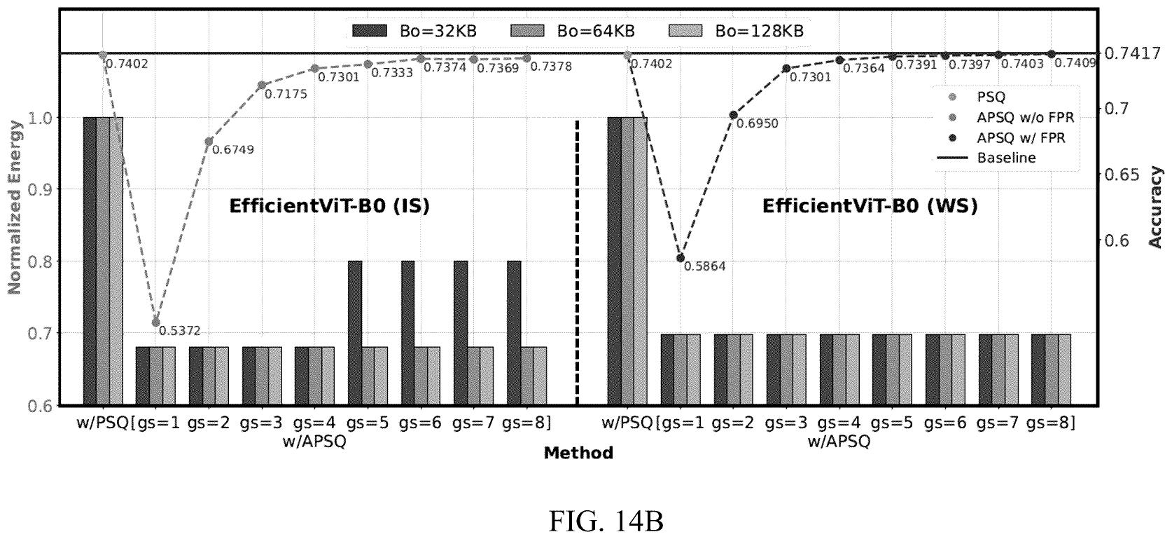

Given that INT8 quantization for PSUMs is sufficient for APSQ regarding energy efficiency for a specific on-chip SRAM allocation, the accuracy of INT8 APSQ is thus largely dependent on the gs. Considering the variability of on-chip SRAM sizes across different DNN accelerators, the correlation between gs and the SRAM size allocated for the ofmap buffer is explored, since only the ofmap buffer would affect the PSUM. A design space exploration (DSE) is conducted to assess the trade-offs, with a focus on energy consumption, model accuracy at various SRAM sizes, gs, and dataflows. FIGS. 14A and 14B indicate that as the Bo constraint tightens, the normalized energy for larger gs escalates, particularly within the IS dataflow. This increase is mainly because the IS dataflow requires the reuse of the ifmap tile across the entire output channel Co, which exceeds the reuse scope of the WS dataflow. Furthermore, the selection of an optimal gs can be guided by energy costs. For instance, choosing a gs of 4 can maintain accuracy while avoiding extra energy overheads for IS-based DNN accelerators, specifically for Segformer-B0 with a Bo of 64 KB and EfficientViT-B0 with a Bo of 32 KB. Such DSE is vital for designing DNN accelerators that leverage APSQ with grouping strategy, optimizing the trade-offs.

In the present disclosure, an analytical framework was refined to evaluate the energy efficiency of DNN accelerators, with particular attention to PSUM precision. The limitations of the previous PSQ method, notably its inability to achieve low-bit storage of PSUMs, were pinpointed. To overcome this, a novel APSQ method, augmented by a grouping strategy and floating-point regularization, is proposed. Experimental results validate that gs intricately relates to extra PSUM quantization. The implementation of INT8 APSQ demonstrates negligible loss across all operations, including convolution, attention, and matrix multiplication, on the demanding Cityscapes dataset for semantic segmentation. DSE experiments underscore the importance of maintaining a balance between energy consumption and accuracy within the constraints of hardware resources and dataflow patterns, providing a strategic framework for optimizing DNN accelerators that harness APSQ.

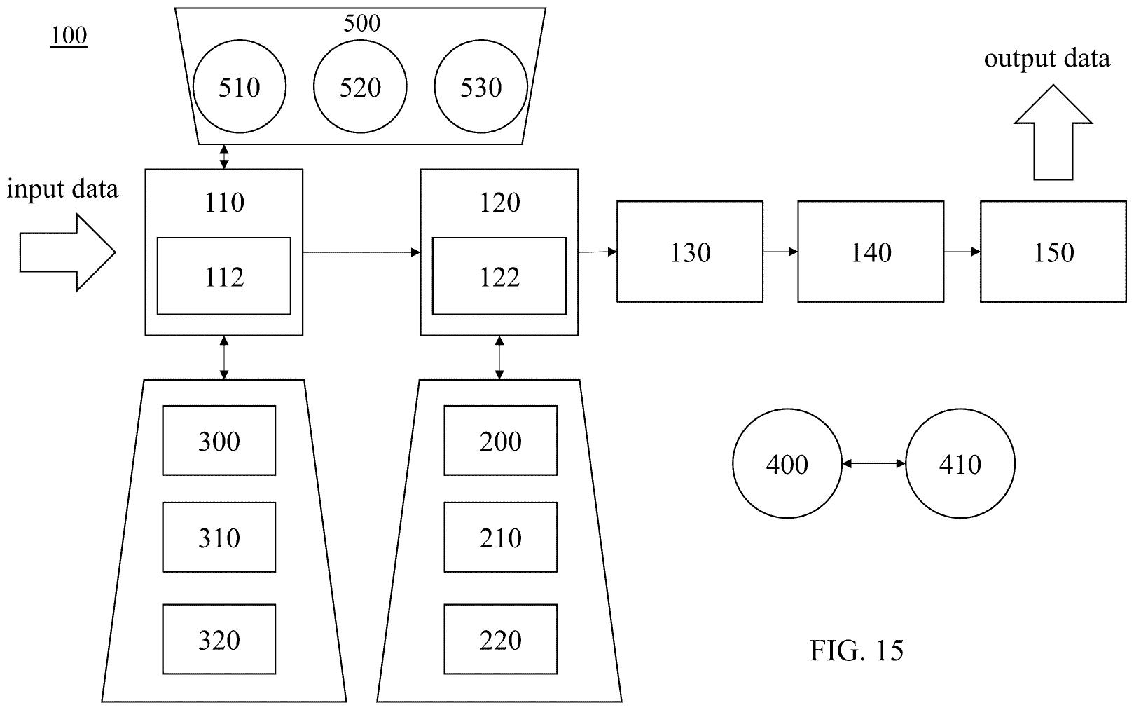

FIG. 15 shows a schematic diagram of a system 100 with an improved approximation architecture performing piece-wise linear approximation method for efficient transformer acceleration according to one embodiment of the present invention.

The system includes a LUT-based approximation circuit 110, a quantization-aware enhancement module 120, a low-bit LUT-based piece-wise linear approximation circuit 130, a memory module 140, an output module 150, an additive partial sum (PSUM) quantization module 200, an accuracy enhancement module 210, and a floating-point regularization (FPR) module 220. The system 100 receives input data and process the input data via components thereof. In one embodiment, the input data includes a set of high-resolution images with semantic labels and a semantic dataset. In this regard, each high-resolution image may have multiple pixel-level classifications corresponding to predefined categories, and the input data is to be processed via semantic segmentation tasks. The semantic dataset may have a plurality of training, validation, and testing images and may be configured to use in model training, optimization, and evaluation.

The LUT-based approximation circuit 110 is configured to utilize a genetic algorithm 112 for adaptively approximating non-linear operators. The genetic algorithm 112 evaluates multiple candidate solutions to generate optimal approximation parameters. The LUT-based approximation circuit can utilize the parameters to convert at least one original floating-point operation into at least one fixed-point operation, such that the LUT-based approximation circuit outputs a transformed fixed-point representation of the original floating-point operation based on the approximation parameters. In one embodiment, the genetic algorithm 112 in the LUT-based approximation circuit 110 is configured to adapt input data and non-linear operators dynamically via continuously refining the approximation parameters.

The quantization-aware enhancement module 120 is configured to execute a rounding mutation algorithm 122, which treats a conversion from floating-point to integer as a mutation process. The quantization-aware enhancement module 120 can work in conjunction with the LUT-based approximation circuit 110 by refining a fixed-point output from the LUT-based approximation circuit 110 through rounding values in a way that minimizes quantization errors while maintaining precision. As such, the quantization-aware enhancement module 120 outputs a quantized integer representation of the transformed fixed-point operation. In one embodiment, the quantization-aware enhancement module 120 is further configured to execute the rounding mutation algorithm 122 to adapt characteristics of input data.

The low-bit LUT-based piece-wise linear approximation circuit 130 is configured to store all approximation parameters in INT8 format, reducing memory and computational overhead, wherein the low-bit LUT-based piece-wise linear approximation circuit receives the quantized integer representation from the quantization-aware enhancement module 120 and performs piece-wise linear approximation. The low-bit LUT-based piece-wise linear approximation circuit 130 can output a low-bit approximation of the non-linear operation. Then, the memory module 140 is configured to receive outcome of the low-bit LUT-based piece-wise linear approximation circuit 130 and store the low-bit approximation of the non-linear operation in a memory-efficient INT8 format.

In one embodiment, the low-bit LUT-based piece-wise linear approximation circuit 130 operates at multiple levels of granularity, allowing for selection of coarse or fine approximation strategies based on computational demands. In one embodiment, the low-bit LUT-based piece-wise linear approximation circuit 130 may include a feedback model that dynamically adjusts the approximation parameters based on runtime performance metrics, achieving continuous minimization of approximation errors without sacrificing computational efficiency.

Further, the additive PSUM quantization module 200 works with the accuracy enhancement module 210 and the FPR module 220 for the quantization-aware enhancement module 120.

The additive PSUM quantization module 200 is configured to quantize each accumulated PSUM in matrix multiplication (MatMul) from FP32 format to INT8 format for the quantization-aware enhancement module 120. The additive PSUM quantization module 200 can be further configured to employ a dynamic thresholding approach to selectively quantize partial sums based on their magnitude. The accuracy enhancement module 210 is configured to implement a grouping strategy that combines traditional PSUM quantization (PSQ) with additive PSUM quantization (APSQ) to improve accuracy, in which results of PSQ are stored in on-chip SRAM and are read and accumulated to perform APSQ. The FPR module 220 is configured to further refine the accuracy for the accuracy enhancement module 210, in which a mean squared error (MSE) loss is established between approximate MatMul results from APSQ/PSQ and the accurate results from the original floating-point operation.

Briefly, the additive PSUM quantization module 200 quantizes partial sums from the MatMul process, converting them from FP32 to INT8. It works in conjunction with the accuracy enhancement module 210 and the FPR module 220 to optimize the quantization process and maintain accuracy. The accuracy enhancement module 210 combines PSQ and APSQ strategies, stored in SRAM for further processing. Then, the FPR module 220 ensures that the accuracy of the quantization process is refined by using the MSE loss function between the approximate and original floating-point results. By this configuration, it connects the additive PSUM quantization module 200, the accuracy enhancement module 210, and the FPR module 220 into the quantization process with other components.

In one embodiment, the quantization-aware enhancement module 120 is coupled to the additive PSUM quantization module 200. The quantization-aware enhancement module 120 provides comprehensive quantization support, including strategies to optimize precision and minimize errors during the quantization process. Meanwhile, the additive PSUM quantization module 200 focuses on quantizing accumulated partial sums during MatMul, transforming high-precision data into lower-precision formats such as INT8. For effective quantization, it might require pre-processed inputs (e.g., quantization parameters, scaling factors, or grouped/processed data) from the quantization-aware enhancement module 120 for sharing quantization parameters with the additive PSUM quantization module 200. For example, the additive PSUM quantization module 200 may calculate and provide scaling factors, thresholds, or quantization ranges that the additive PSUM quantization module 200 applies during its operations. In this regard, if the additive PSUM quantization module 200 detects quantization errors or inefficiencies during its operation (e.g., data overflow or underflow during partial sum quantization), this feedback can be returned to the quantization-aware enhancement module 120 to adjust parameters such as scaling factors or quantization ranges.

The system 100 nay further include a finetuning framework module 300, a fixed-point quantization-aware training module 310, and a finetuning module 320.

The finetuning framework module 300 is configured to perform off-line piecewise linear approximation with a set of targeted input scaling factors. The finetuning framework module 300 can be further configured to adaptively select scaling factors for each non-linear operator, such that the scaling factors are optimized for transforming each non-linear operator into a piecewise linear approximation, in alignment with the fixed-point conversion process performed by the LUT-based approximation circuit 110.

The fixed-point quantization-aware training module 310 is configured to compress a pre-trained floating-point model by initializing the scaling factors through fixed-point quantization. The fixed-point quantization-aware training module 310 may leverage the quantization-aware enhancement module 120 to refine the scaling factors while maintaining precision during the quantization process.

The finetuning module 320 is configured to update a quantized model during a subsequent finetuning process. In this regard, a forward pass replaces each non-linear operator with a piecewise linear approximation function based on the corresponding scaling factor, and a backward pass further refines the scaling factors through knowledge distillation.

In one embodiment, the LUT-based approximation circuit 110 can establish a bidirectional connection with the finetuning framework module 300, the fixed-point quantization-aware training module 310, and the finetuning module 320. For this connection, inputs to the LUT-based approximation circuit 110 may include quantization scaling factors, piecewise linear approximation parameters, and optimized fixed-point data provided by the finetuning framework module 300, the fixed-point quantization-aware training module 310, and the finetuning module 320. Furthermore, the finetuning module 320 supplies finely tuned LUT update parameters, such as scaling factors or segment configurations, to further enhance the circuit's approximation accuracy. In return, the LUT-based approximation circuit 110 outputs operational feedback, such as approximation errors or data distribution, to the finetuning framework module 300, the fixed-point quantization-aware training module 310, and the finetuning module 320. This feedback allows these modules to iteratively refine scaling factors and approximation strategies.

The output module 150 electrically coupled with the memory module 140 and configured to output a semantic segmentation map for each input data (e.g., an input image). In one embodiment, the segmentation map may include pixel-wise classifications for all pixels in the input image and output an evaluation result based on a mean intersection over union (mIoU) metric, representing accuracy of the semantic segmentation task.

The system 100 nay further include a convolution module 400 and a CNN module 410. The convolution module 400 is configured to perform convolution operations on the input data using a set of learned filters, in which the convolution module 410 leverages the piece-wise linear approximation method of the LUT-based approximation circuit 110 to accelerate the convolution operations. The CNN module 410 is configured to utilize an output from the convolution module 400. In one embodiment, the CNN module 410 is trained using machine learning algorithms to perform tasks for image classification, object detection, or semantic segmentation.

In one embodiment, a near-memory computing engine 500 for Softmax and LayerNorm operations is provided. The near-memory computing engine 500 includes a near-memory architecture model 510, a piece-wise linear approximation engine 520, a LayerNorm folding module 530. The near-memory architecture model 510 is tailored to reduce data movement burden associated with Softmax and LayerNorm computations. The piece-wise linear approximation engine 520 is implemented via the LUT-based approximation circuit 110 and is configured to utilize a look-up table and a quantization method to minimize data transfers and enhance overall computational efficiency. The LayerNorm folding module 530 is configured to reduce required parameters and computation steps.

Specifically, the near-memory architecture model 510 connects to the LUT-based approximation circuit 110 to optimize data transfers, reducing the data movement burden associated with Softmax and LayerNorm operations. The piece-wise linear approximation engine 520 can handle these operations by utilizing piecewise linear approximation and connects to the near-memory architecture model 510. Additionally, the LayerNorm folding module 530 interacts with the LUT-based approximation circuit 110 to optimize the computation of LayerNorm by reducing the required parameters. Together, these components work to enhance the efficiency of the Softmax and LayerNorm operations, minimizing computational load and data transfer requirements. The connections between these components/modules are likely bidirectional, allowing feedback from the approximation and folding processes to iteratively optimize scaling factors and approximation parameters.

The functional units and modules of the apparatuses and methods in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes executing in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can be included, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A system with an improved approximation architecture performing piece-wise linear approximation method for efficient transformer acceleration, comprising:
a LUT-based approximation circuit configured to utilize a genetic algorithm for adaptively approximating non-linear operators, wherein the genetic algorithm evaluates multiple candidate solutions to generate optimal approximation parameters, and the LUT-based approximation circuit utilizes the parameters to convert at least one original floating-point operation into at least one fixed-point operation, such that the LUT-based approximation circuit outputs a transformed fixed-point representation of the original floating-point operation based on the approximation parameters;
a quantization-aware enhancement module configured to execute a rounding mutation algorithm, which treats a conversion from floating-point to integer as a mutation process, wherein the quantization-aware enhancement module works in conjunction with the LUT-based approximation circuit by refining a fixed-point output from the LUT-based approximation circuit through rounding values in a way that minimizes quantization errors while maintaining precision, such that the quantization-aware enhancement module outputs a quantized integer representation of the transformed fixed-point operation;
a low-bit LUT-based piece-wise linear approximation circuit configured to store all approximation parameters in INT8 format, reducing memory and computational overhead, wherein the low-bit LUT-based piece-wise linear approximation circuit receives the quantized integer representation from the quantization-aware enhancement module and performs piece-wise linear approximation, such that the low-bit LUT-based piece-wise linear approximation circuit outputs a low-bit approximation of the non-linear operation; and
a memory module configured to store the low-bit approximation of the non-linear operation in a memory-efficient INT8 format.

2. The system according to claim 1, further comprising:
an additive partial sum (PSUM) quantization module configured to quantize each accumulated PSUM in matrix multiplication (MatMul) from FP32 format to INT8 format for the quantization-aware enhancement module;
an accuracy enhancement module configured to implement a grouping strategy that combines traditional PSUM quantization (PSQ) with additive PSUM quantization (APSQ) to improve accuracy, wherein results of PSQ are stored in on-chip SRAM and are read and accumulated to perform APSQ; and
a floating-point regularization (FPR) module configured to further refine the accuracy of the accuracy enhancement module, wherein a mean squared error (MSE) loss is established between approximate MatMul results from APSQ/PSQ and the accurate results from the original floating-point operation.

3. The system according to claim 2, wherein the additive PSUM quantization module is further configured to employ a dynamic thresholding approach to selectively quantize partial sums based on their magnitude.

4. The system according to claim 1, further comprising:
a finetuning framework module configured to perform off-line piecewise linear approximation with a set of targeted input scaling factors, wherein the finetuning framework module is further configured to adaptively select scaling factors for each non-linear operator, such that the scaling factors are optimized for transforming each non-linear operator into a piecewise linear approximation, in alignment with the fixed-point conversion process performed by the LUT-based approximation circuit;
a fixed-point quantization-aware training module configured to compress a pre-trained floating-point model by initializing the scaling factors through fixed-point quantization, wherein the fixed-point quantization-aware training module leverages the quantization-aware enhancement module to refine the scaling factors while maintaining precision during the quantization process; and
a finetuning module configured to update a quantized model during a subsequent finetuning process, wherein a forward pass replaces each non-linear operator with a piecewise linear approximation function based on the corresponding scaling factor, and a backward pass further refines the scaling factors through knowledge distillation.

5. The system according to claim 1, wherein the genetic algorithm in the LUT-based approximation circuit is configured to adapt input data and non-linear operators dynamically via continuously refining the approximation parameters.

6. The system according to claim 5, wherein the quantization-aware enhancement module is further configured to execute a rounding mutation algorithm to adapt characteristics of input data.

7. The system according to claim 6, wherein the input data comprises:
a set of high-resolution images with semantic labels, wherein each high-resolution image has multiple pixel-level classifications corresponding to predefined categories, and the input data is to be processed via semantic segmentation tasks; and
a semantic dataset having a plurality of training, validation, and testing images and configured to use in model training, optimization, and evaluation.

8. The system according to claim 7, further comprising:
an output module electrically coupled with the memory module and configured to output a semantic segmentation map for each input image, wherein the segmentation map includes pixel-wise classifications for all pixels in the input image and output an evaluation result based on a mean intersection over union (mIoU) metric, representing accuracy of the semantic segmentation task.

9. The system according to claim 8, further comprising:
a convolution module configured to perform convolution operations on the input data using a set of learned filters, wherein the convolution module leverages the piece-wise linear approximation method of the LUT-based approximation circuit to accelerate the convolution operations;
a convolutional neural network (CNN) module configured to utilize an output from the convolution module, wherein the CNN module is trained using machine learning algorithms to perform tasks for image classification, object detection, or semantic segmentation.

10. The system according to claim 8, wherein the low-bit LUT-based piece-wise linear approximation circuit operates at multiple levels of granularity, allowing for selection of coarse or fine approximation strategies based on computational demands.

11. The system according to claim 10, wherein the low-bit LUT-based piece-wise linear approximation circuit includes a feedback model that dynamically adjusts the approximation parameters based on runtime performance metrics.

12. A near-memory computing engine for Softmax and LayerNorm operations, comprising:
a near-memory architecture model tailored to reduce data movement burden associated with Softmax and LayerNorm computations;
a piece-wise linear approximation engine implemented via the LUT-based approximation circuit according to claim 1 and configured to utilize a look-up table and a quantization method to minimize data transfers and enhance overall computational efficiency; and
a LayerNorm folding module configured to reduce required parameters and computation steps.
